(19) United States
(12) Patent Application Publication
(10) Pub. No.: US 2004/0244017 A1
(43) Pub. Date: Dec. 2, 2004

(54) Disk loading device, disk loading method and optical disk apparatus

(75) Inventor: Susumu Hisatomi, Fukaya-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/812,073

(22) Filed: Mar. 30, 2004

(30) Foreign Application Priority Data
May 29, 2003 (JP) 2003-153079

(51) Int. Cl. G11B 33/02

(52) U.S. Cl. 720/601

(57) ABSTRACT

The present invention comprises a controlling mechanism for selectively providing the driving force from the same driving source to a tray driving mechanism, a disk driving section driving mechanism and a head driving mechanism for successively moving a tray, a disk driving section and a head in this order or in the opposite order, and a switch driving mechanism for controlling the switch in either of the on and off states at the time the tray reaches at the pulling out reference position from the cabinet, and controlling the same in the other state of the on and off states at the time the head reaches at the reference position for recording or reproducing with respect to the disk according to the contract with the member interlocked with the operation of the controlling mechanism.

### CROSS-REFERENCE TO RELATED APPLICATIONS

This application is based upon and claims the benefit of priority from prior Japanese Patent Application No. 2003-153079, filed May 29, 2003, the entire contents of which are incorporated herein by reference.

### BACKGROUND OF THE INVENTION

1. Field of the Invention

The present invention relates to a disk loading device for inserting or taking out a tray for mounting an optical disk with respect to an apparatus main body, and a disk loading method. Moreover, the present invention relates to an optical disk apparatus using the above-mentioned disk loading device.

2. Description of the Related Art

As is well known, recently, the so-called multi disk drive appliance capable of not only recording or reproducing data for a CD (compact disk) but also recording or reproducing data for an optical disk such as a DVD (digital versatile disk) has been used widely.

Since this kind of the multi disk drive appliance is used for example not only as an external appliance for a desk top type personal computer but also as an appliance stored in a lap top type personal computer, a small size and a thin shape is required as much as possible for the external size.

According to a common optical disk device for recording or reproducing data for an optical disk, in the case a tray is pulled out from a housing, mounting an optical disk on the tray and storing the same in the housing, the optical disk is clamped between a turn table and a damper rotatably.

Moreover, accompanied by this operation, an optical head is moved to the innermost circumferential portion of the optical disk. Then, by rotating and driving the optical disk in this state, and moving the optical head in the optical disk radial direction, data can be recorded or reproduced in the optical disk.

In contrast, at the time of taking out the optical disk, first, the optical disk rotation is stopped for releasing the clamped state of the optical disk by the turn table and the clamper. Then, since the optical disk is placed on the tray in the housing, by pulling out the tray from the housing, the optical disk can be taken out.

Here, the above-mentioned mechanism for mounting or taking out the optical disk with respect to the optical disk apparatus is called a disk loading device. Also for the disk loading device, nowadays, various configurations are considered for meeting the demand for a small size and a thin shape.

Jpn. Pat. Appln. KOKAI Publication No. 10-112118 discloses a configuration of cutting back the number of switches by detecting the point of completing discharge of the tray and the point of completing clamping of the disk by one detection switch. However, according to Jpn. Pat. Appln. KOKAI Publication No. 10-112118, a two contact type switch is necessary as the switch, and the operation mechanism for the switch is bulky.

Moreover, Jpn. Pat. Appln. KOKAI Publication No. 2000-149379 discloses a configuration of handling a reciprocal operation of moving a tray from a storage position to a taking out position, and furthermore, moving the same from the taking out position to the storage position as a series of operation so as to eliminate the need of detecting the tray taking out position, and a configuration of taking out a tray and clamping a disk by the same driving source.

Furthermore, Jpn. Pat. Appln. KOKAI Publication No. 2001-325764 discloses a configuration of commonly using a driving source for a loading mechanism and a feeding mechanism and utilizing the inverse direction rotation of a spindle motor, which has not conventionally been used, for simplifying the configuration, reducing the cost, and achieving a light weight.

Moreover, Jpn. Pat. Appln. KOKAI Publication No. 2000-311411 discloses a configuration of smoothly advancing a tray while restraining the increase of the power consumption by supplying a voltage or an electric current of a higher level at the time of advancing the tray from the home position to the extra position than at the time of withdrawing the tray from the extra position to the home position so as to increase the tray driving force.

However, according to the techniques disclosed in Jpn. Pat. Appln. KOKAI Publication Nos. 2000-149379, 2001-325764 and 2000-311411, the above-mentioned strong demand for a small size and a thin shape to the disk loading device has not been satisfied sufficiently in terms of the practical use.

### BRIEF SUMMARY OF THE INVENTION

According to one aspect of the present invention, there is provided a disk loading device comprising: a tray driving mechanism configured to move a tray capable of placing a disk thereon between a position taken out from a cabinet and a position stored in the cabinet according to the driving force applied from the outside; a disk driving section driving mechanism configured to move a disk driving section to mount, rotate and drive the disk placed on the tray stored in the cabinet between a position for mounting the disk and a position for detaching the disk according to the driving force applied from the outside; a head driving mechanism which is moved together with the disk driving section by the disk driving section driving mechanism, and configured to move a head in the diameter direction of the disk mounted in the disk driving section according to the driving force applied from the outside; a controlling mechanism which is engaged selectively with the tray driving mechanism, the disk driving section driving mechanism, and the head driving mechanism, and configured to successively move the tray, the disk driving section and the head in this order or in the opposite order by selectively applying the driving force from the same driving source to each driving mechanism; and a switch driving mechanism configured to control the switch in either of the on and off states in a state with the tray reach at the pulling out reference position from the cabinet according to the contact or detachment of the member interlocked with the operation of the controlling mechanism, and to control the same in the other of the on and off states with the head reach at the reference position for recording or reproduction with respect to the disk.

According to one aspect of the present invention, there is provided a disk loading method comprising: selectively providing the driving force from the same driving source to a tray driving mechanism, a disk driving section driving mechanism and a head driving mechanism for moving a tray, a disk driving section and a head successively in this order or in the opposite order; and selectively controlling the same switch in the on and off states between a state with the tray reach at the pulling out reference position from a cabinet and a state with the head reach at the reference position for recording or reproduction with respect to a disk in a disk loading device comprising the tray driving mechanism configured to move the tray capable of placing the disk thereon between a position taken out from the cabinet and a position stored in the cabinet according to the driving force applied from the outside; the disk driving section driving mechanism configured to move the disk driving section to mount, rotate and drive the disk placed on the tray stored in the cabinet between a position for mounting the disk and a position for detaching the disk according to the driving force applied from the outside; and the head driving mechanism which is to be moved together with the disk driving section by the disk driving section driving mechanism, and configured to move the head in the diameter direction of the disk mounted in the disk driving section according to the driving force applied from the outside.

According to one aspect of the present invention, there is provided a optical disk apparatus comprising: a tray driving mechanism configured to move a tray capable of placing a disk thereon between a position taken out from a cabinet and a position stored in the cabinet according to the driving force applied from the outside; a disk driving section driving mechanism configured to move a disk driving section to mount, rotate and drive the disk placed on the tray stored in the cabinet between a position for mounting the disk and a position for detaching the disk according to the driving force applied from the outside; a head driving mechanism which is to be moved together with the disk driving section by the disk driving section driving mechanism, and configured to move a head in the diameter direction of the disk mounted in the disk driving section according to the driving force applied from the outside; a controlling mechanism which is to be engaged selectively with the tray driving mechanism, the disk driving section driving mechanism, and the head driving mechanism, and configured to successively move the tray, the disk driving section and the head in this order or in the opposite order by selectively applying the driving force from the same driving source to each driving mechanism; and a switch driving mechanism configured to control the switch in either of the on and off states in a state with the tray reach at the pulling out reference position from the cabinet according to the contact or detachment of the member interlocked with the operation of the controlling mechanism, and to control the same in the other of the on and off states with the head reach at the reference position for recording or reproduction with respect to the disk; wherein a recording or reproducing operation is executed with respect to the disk in a state with the switch controlled in the other state of the on and off states by the arrival of the head to the reference position for executing the recording or reproducing operation with respect to the disk by the switch driving mechanism.

### BRIEF DESCRIPTION OF THE SEVERAL VIEWS OF THE DRAWING

FIG. 1 is an external view of an embodiment of the present invention for explaining an optical disk apparatus.

FIG. 2 is a diagram for explaining the state of a disk loading section of the same optical disk apparatus viewed from the upper surface side.

FIG. 3 is a diagram for explaining the state of a disk loading section of the same optical disk apparatus viewed from the rear surface side.

FIG. 4 is a diagram for explaining the state with a tray stored inside a base member of the same disk loading section.

FIG. 5 is a diagram for explaining the state with the tray taken out from the base member in the same disk loading section.

FIG. 6 is a diagram for explaining the state of a chassis of the same disk loading section viewed from the upper surface side.

FIGS. 7A to 7C are diagrams for explaining the details of a slide cam in the same disk loading section.

FIG. 8 is a diagram for explaining the state of an optical head and a rack member of the same disk loading section viewed from the upper surface side.

FIG. 9 is a diagram for explaining the state of the optical head and the rack member of the same disk loading section viewed from the rear surface side.

FIG. 10 is a diagram for explaining the relationship between the rack member and a driving member for operating a detection switch in the same disk loading section.

FIG. 11 is a diagram for explaining the relationship between the rack member, the driving member, and the slide cam in the same disk loading section.

FIGS. 12A and 12B are diagrams for explaining the details of a gear in the same disk loading section.

FIG. 13 is a diagram for explaining the detailed operation of the main part in the same disk loading section.

FIG. 14 is a diagram for explaining the detailed operation of the main part in the same disk loading section.

FIG. 15 is a diagram for explaining the detailed operation of the main part in the same disk loading section.

FIG. 16 is a diagram for explaining the detailed operation of the main part in the same disk loading section.

FIG. 17 is a diagram for explaining the detailed operation of the tray in the same disk loading section.

FIG. 18 is a diagram for explaining the detailed operation of the tray in the same disk loading section.

FIG. 19 is a diagram for explaining the detailed operation of the tray in the same disk loading section.

FIG. 20 is a diagram for explaining the detailed operation of the tray in the same disk loading section.

FIG. 21 is a diagram for explaining the operation timing of the detection switch, the tray, the chassis and the optical head in the same disk loading section.

FIG. 22 is a flow chart for explaining the tray storing operation in the same disk loading section.

FIG. 23 is a flow chart for explaining the tray taking out operation in the same disk loading section.

### DETAILED DESCRIPTION OF THE INVENTION

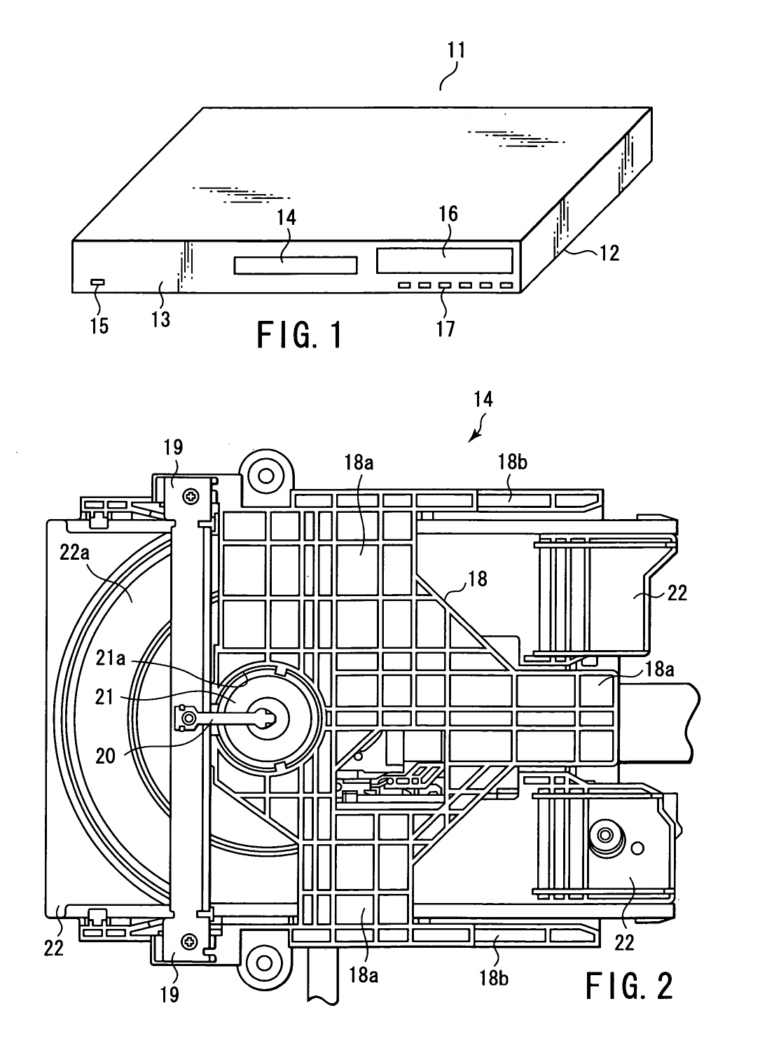

Hereinafter, an embodiment of the present invention will be explained in detail with reference to the drawings. FIG. 1 shows the external appearance of an optical disk apparatus 11 to be explained in this embodiment. That is, the optical disk apparatus 11 has a cabinet 12 formed in a substantially thin box-like shape.

A disk loading section 14 is placed in the central portion of a front panel 13 of the cabinet 12. According to the disk loading section 14, by taking out or inserting a tray to be described later outward from the front panel 13 of the cabinet 12, for example, an optical disk such as a CD and a DVD can be mounted or discharged.

Moreover, a power source key 15 is provided on one end portion of the front panel 13 of the above-mentioned cabinet 12. Furthermore, a display 16 for displaying the operation state and a plurality of operation keys 17 for setting the optical disk apparatus 11 in a predetermined operation state or stopped state are provided on the other end portion of the front panel 13.

FIG. 2 shows the state of the above-mentioned disk loading section 14 taken out and viewed from the upper surface side. That is, a base member 18 serves as a mounting base member for supporting various part directly or indirectly.

The base member 18 includes a top plate 18a, side plates 18b, 18b formed on the both ends facing with each other of the top plate 18a, a bottom plate 18c (not shown in FIG. 2), elongating from the side plate 18b, 18b so as to face the top plate 18a by its surface, and a front plate 18d (not shown in FIG. 2) formed with a gap for freely inserting a tray 22 to be described later provided with respect to the top plate 18a, for interlocking the front end portions of the side plates 18b, 18b with each other.

Among them, an interlocking plate 19 is placed over between the side plates 18b, 18b. A clamp member 21 is mounted on the central portion of the inter-locking plate 19 via an elastic mounting piece 20. The clamp member 21 is forced by the mounting piece 20 via an opening 21a formed in the top plate 18a of the base member 18 toward the inward of the base member 18.

Moreover, the tray 22 is supported on the base member 18. The tray 22 is supported slidably in the right and left direction in the figure in a state with a disk placing section 22a thereof facing the top plate 18a by its surface. In this case, the tray 22 has the both side surfaces supported slidably by a boss provided in the bottom plate 18c of the base member 18.

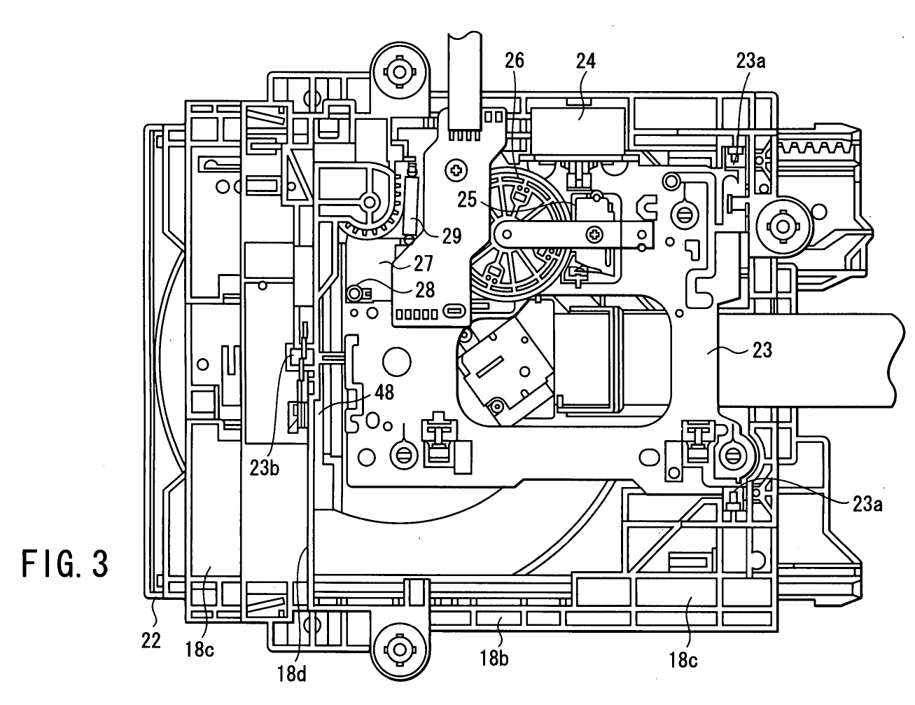

FIG. 3 shows the state of the above-mentioned disk loading section 14 viewed from the rear surface side. That is, the a chassis 23 is supported by the bottom plate 18c of the base member 18 so as to face the rear surface of the tray 22 by its surface. On the chassis 23, a turn table, an optical head, or the like to be described later are mounted.

Moreover, projections 23a, 23a formed on one end portion of the chassis 23 are supported by the bottom plate 18c rotatably. Thereby, the chassis 23 has the other end portion thereof supported with the projections 23a, 23a as the fulcrum movably in the swinging direction.

In this case, a boss 23b is provided projecting from the center of the other end portion of the chassis 23. The boss 23b is engaged with a slide cam 48 to be described later including an elevating mechanism, supported slidably in the vertical direction in the figure along the front plate 18d of the base member 18. Then, according to the control of the boss 23b, following the slide cam 48, the chassis 23 is controlled so as to elevate a turn table, an optical head, of the like with respect to the tray 22.

Moreover, a driving motor 24 is supported by the chassis 23. A worm gear 25 is fitted with the rotation axis of the driving motor 24. According to the engagement of the worm gear 25 with the worm wheel 24 supported rotatably on the chassis 23, the rotation force of the driving motor 24 is transmitted to the worm wheel 26.

According to the rotation of the worm wheel 26 by the rotation force of the driving motor 24, the tray 22, the chassis 23, the optical head, or the like are moved as it will be described later.

Moreover, a detection switch to be described later is provided to the above-mentioned chassis 23 for detecting the pulling out reference position of the tray 22, the reference position for starting recording or reproduction of the optical head, or the like. Furthermore, a driving member 27 for operating the detection switch is provided rotatably by a shaft 28 on the chassis 23. The driving member 27 is forced rotatably in the counterclockwise direction in the figure by a coil spring 29.

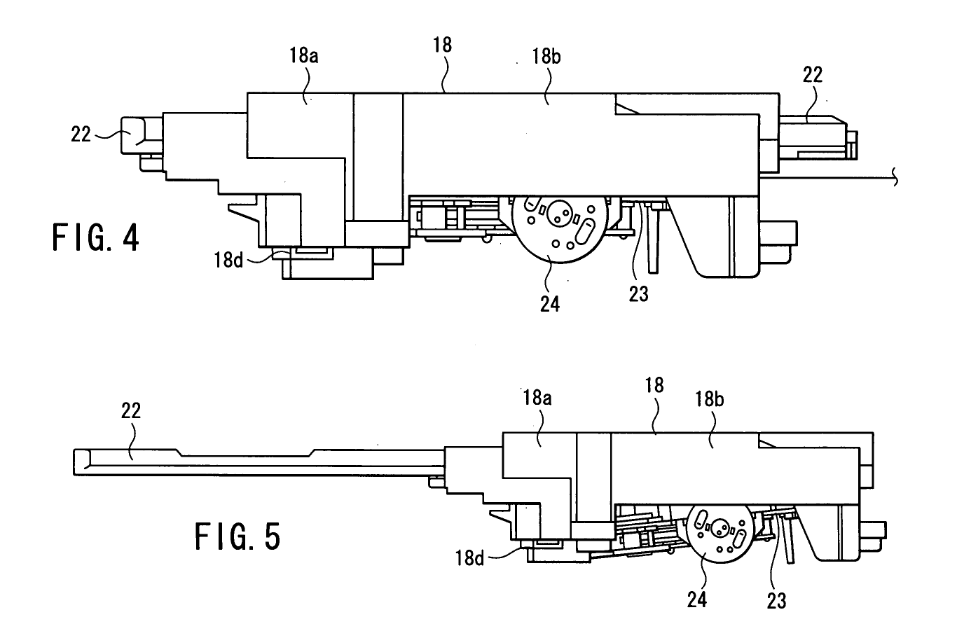

FIG. 4 shows the state of the tray 22 stored inside the base member 18, viewed from the side surface. In this case, the chassis 23 is controlled at a position raised with respect to the tray 22. At this position, the turn table lifts up the optical disk from the tray 22 and clamps the optical disk with respect to the clamp member 21, and the optical head faces the signal recording surface of the optical disk.

FIG. 5 shows the state with the tray 22 pulled out from the base member 18, viewed from the side surface. In this case, the chassis 23 is controlled at a position lowered with respect to the tray 22. At this position, the turn table is away from the optical disk, and the optical disk is placed on the tray 22.

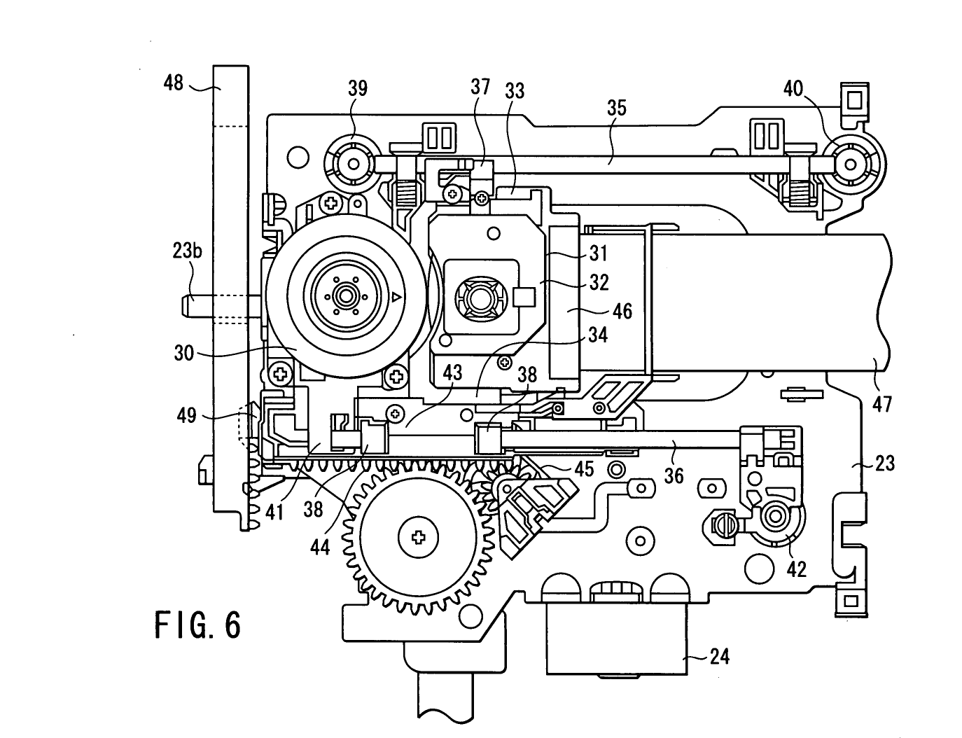

FIG. 6 shows the state of the above-mentioned chassis 23, viewed from the FIG. 2 direction. The above-mentioned turn table 30 is fitted on the rotation axis of a disk motor (not shown) fixed on the chassis 23 so as to be rotated and driven by the rotation force of the disk motor.

Moreover, the above-mentioned optical head 31 is mounted on the chassis 23. The optical head 31 includes a head portion 32 having an unillustrated laser diode, a photo diode, or the like, a printed circuit board 33 to have the head portion 32 mounted, and a holder 34 with the printed circuit board 33 fixed.

Then, the optical head 31 is supported movably by two guide shafts 35, 36 fixed parallel to the chassis 23 in the direction approaching to the turn table 30, and in the direction moving away from the turn table 30.

In this case, in the above-mentioned holder 34, a supporting member 37 to be engaged slidably with the guide shaft 35, and a supporting member 38 to be engaged slidably with the guide shaft 36 are formed, respectively. Then, the optical head 31 is supported slidably by the supporting members 37, 38 on the guide shafts 35, 36.

Then, the guide shaft 35 is supported by the both end portions by the supporting members 39, 40 on the chassis 23. Moreover, the guide shaft 36 is supported by both end portions by the supporting members 41, 42 on the chassis 23.

An adjusting mechanism for adjusting the interval between the guide shafts 35, 36 and the chassis 23 is provided for, for example, three (39, 40, 42) out of the four supporting members 39, 40, 41, 42 such that the tilt adjustment can be executed for the optical head 31 according to the adjustment.

Moreover, a rack member 43 formed so as to surround the supporting member 38 to be engaged with the guide shaft 36 is fixed on the above-mentioned holder 34. Then, a rack 44 is formed on the rack member 43 on the opposite side with respect to the side facing the optical head 31. The rack 44 can be engaged with a pinion gear 45 formed concentrically with the above-mentioned worm wheel 26.

Thereby, in the case the driving motor 24 is rotated and the rotation force is transmitted to the rack 44, the optical head 31 is moved along the guide shafts 35, 36 in the direction according to the rotation direction of the driving motor 24.

A connector 46 is provided to the printed circuit board 33 with the above-mentioned head portion 32 mounted. By connecting a cable 47 with the connector 46, a signal can be exchanged with respect to the head portion 32.

Here, a cam driving section 49 for driving the above-mentioned slide cam 48 is formed on the above-mentioned rack member 43. The slide cam 48 is supported slidably in the vertical direction in the figure along the front plate 18d of the base member 18 as mentioned above so as to be engaged with the boss 23b of the chassis 23.

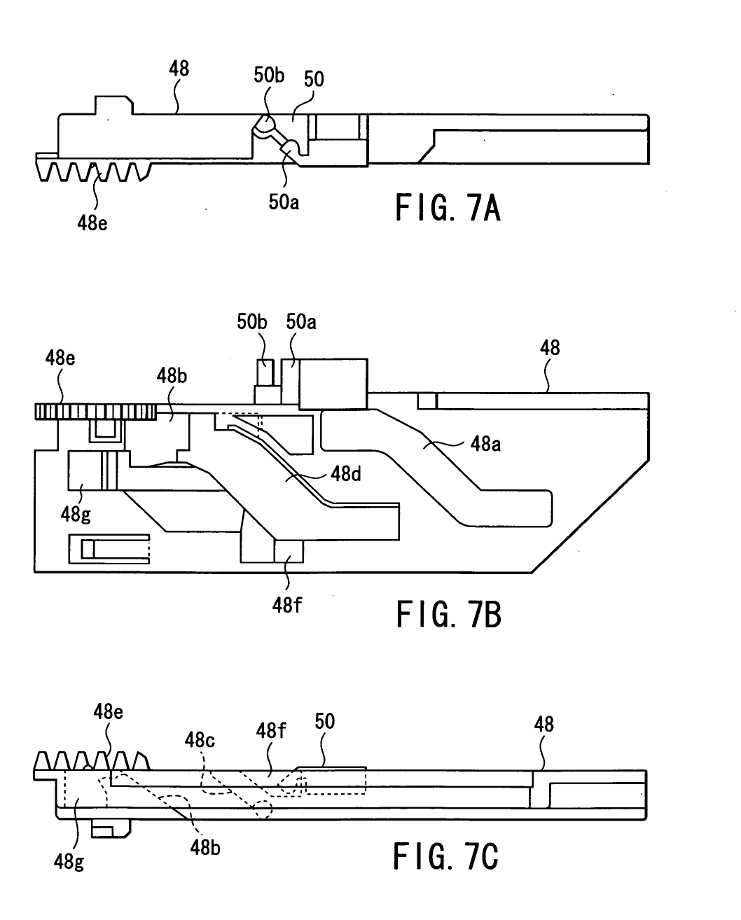

FIGS. 7A to 7C each show the details of the slide cam 48. A cam hole 48a to be pierced through by the boss 23b of the chassis 23 is formed in the slide cam 48.

Moreover, in the slide cam 48, a groove 48d having a cam surface 48b to be driven by the cam driving section 49 of the above-mentioned rack member 43, and in contrast, a cam surface 48c for driving the cam driving section 49, is formed.

Furthermore, in the slide cam 48, a rack 48e, a groove 48f for inserting a projection portion to be described later of the above-mentioned driving member 27 in a state with the tray 22 completely pulled out from the base member 18, and a groove 48g for inserting the projection portion to be described later of the above-mentioned driving member 27 in a state with the optical head 31 disposed at the innermost circumference of the optical disk, are formed.

Moreover, in the slide cam 48, a tray driving section 50 to be engaged with a cam projection portion to be described later formed in the tray 22. The tray driving section 50 includes a projection portion 50a and a pin 50b formed with a predetermined interval provided therebetween.

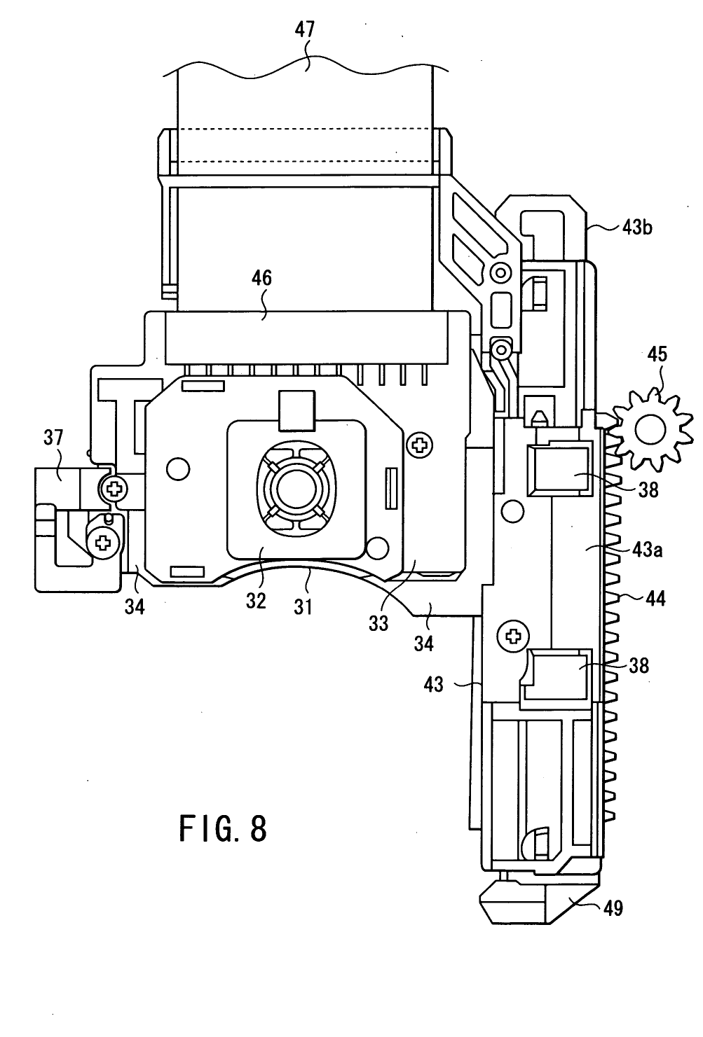

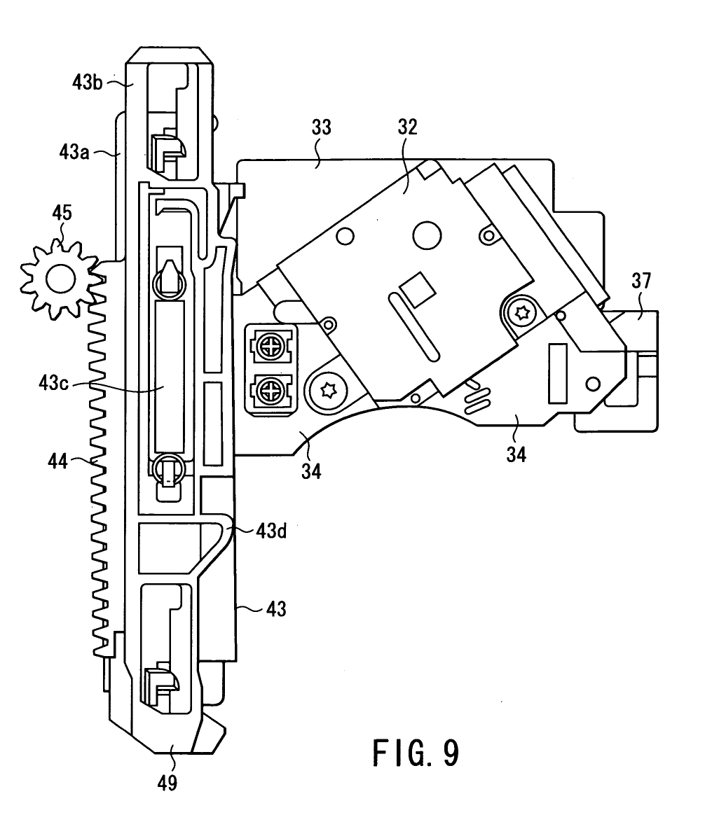

FIGS. 8 and 9 show the above-mentioned optical head 31 and rack member 43 in a state taken out. FIG. 8 shows the state viewed from the FIG. 2 direction, and FIG. 9 shows the state viewed form the rear side thereof.

That is, the rack member 43 includes a rack supporting section 43a fixed on the above-mentioned holder 34, and a rack piece 43b with the above-mentioned rack 44 formed, superimposed with each other. The rack piece 43b is supported by the rack supporting section 43a slightly movably along the superimposed surface with respect to the rack supporting section 43a.

Then, the rack piece 43b is forced by the coil spring 43c engaged with respect to the rack supporting section 43a such that the rack 44 is engaged with the above-mentioned pinion gear 45. Thereby, the backlash between the rack 44 and the pinion gear 45 can be restrained.

In the rack piece 43b, a cam portion 43d for controlling the above-mentioned driving member 27 is formed.

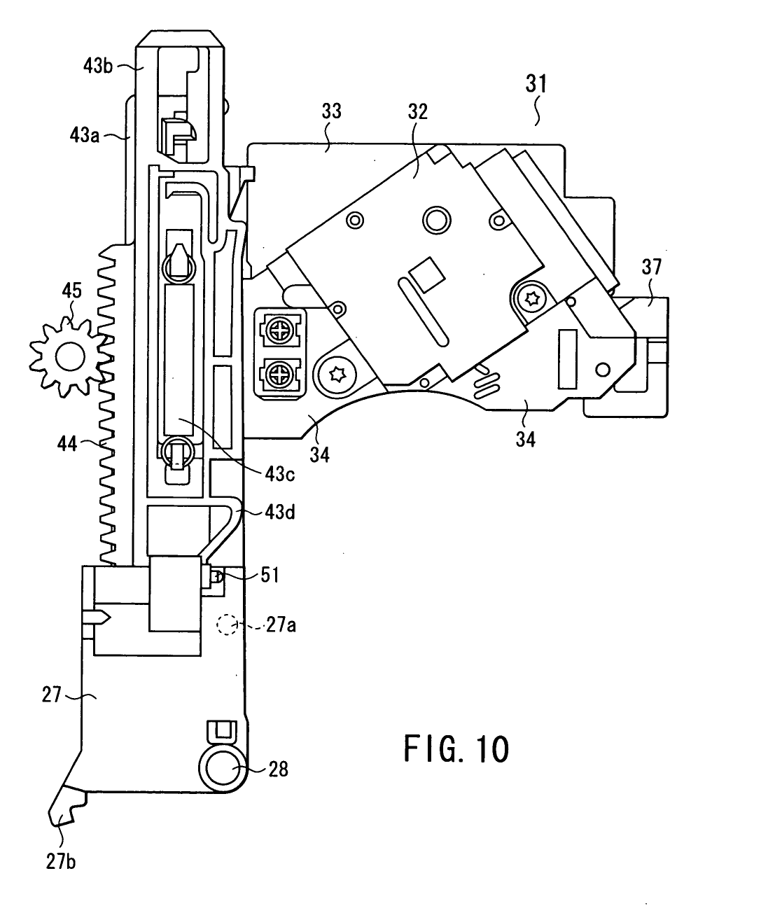

FIG. 10 shows the relationship between the above-mentioned rack member 43 and the driving member 27 for operating the above-mentioned detection switch. FIG. 10 shows the state with the optical head 31 disposed at a position on the outer circumference side with respect to the innermost circumference of the optical disk.

In this case, since the cam portion 43d of the rack piece 43b is not engaged with the pin 27a, and the projection portion 27b is inserted in the groove 48g of the above-mentioned slide cam 48, the driving member 27 is at a position rotated maximally in the counter-clockwise direction so that it presses and operates the detection switch 51 fixed on the chassis 23 into the on state at the position.

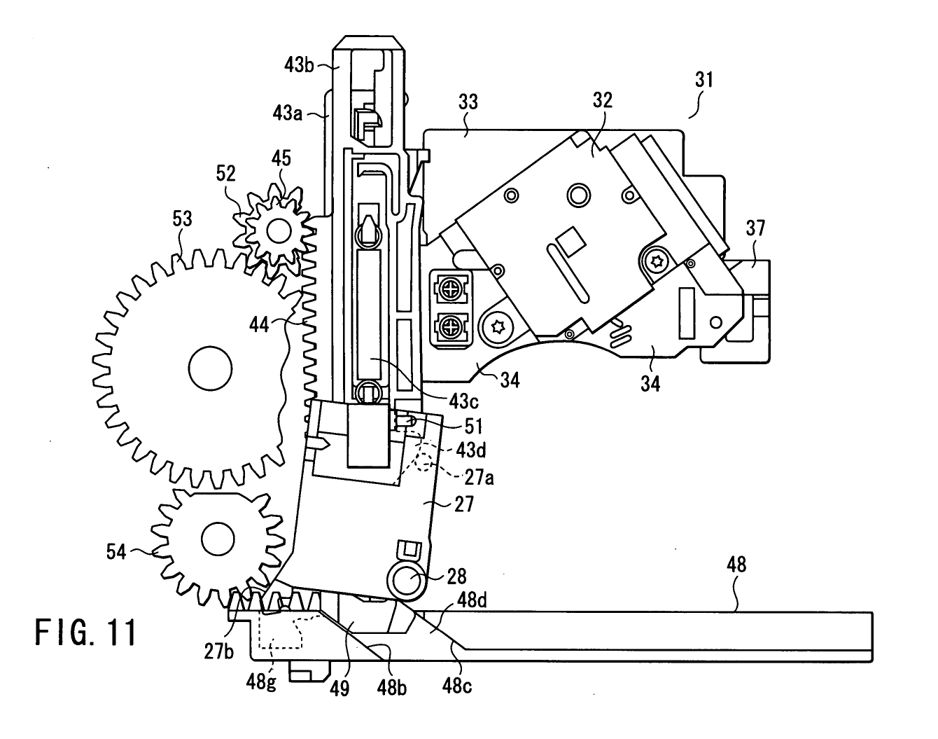

In the case the optical head 31 is moved to the optical disk innermost circumference position in this state, as shown in FIG. 11, the cam portion 43d of the rack piece 43b is engaged with the pin 27a of the driving member 27 so that the driving member 27 is rotated in the clockwise direction. Thereby, the pressing operation of the detection switch 51 is released so as to be in the off state so that the arrival of the optical head 31 to the optical disk innermost circumference position can be detected.

In this case, although the cam driving section 49 of the rack member 43 is inserted into the groove 48d of the slide cam 48, the cam driving section 49 is not contacted with the cam surface 48b of the slide cam 48 in this state so that the slide cam 48 cannot be slid.

Here, a gear 52 having a large diameter is formed integrally with the above-mentioned pinion gear 45 concentrically. The pinion gear 45 and the gear 52 are formed independently from the above-mentioned worm wheel 26, and they are interlocked with the worm wheel 26 via a clutch mechanism capable of transmitting the rotation force.

Moreover, the gear 52 is engaged with a gear 53 supported rotatably by the chassis 23. The worm wheel 26, the pinion gear 45, and the gears 52, 53 are all supported by the chassis 23 so as to be raised together according to elevation of the chassis 23.

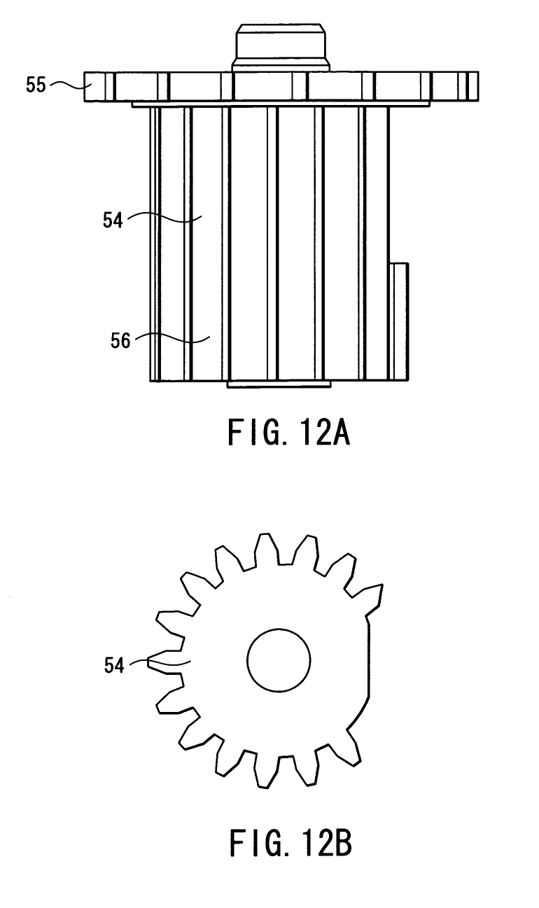

In contrast, a gear 54 engageable with the gear 53 is supported rotatably on the above-mentioned base member 18. As shown in FIGS. 12A and 12B, the gear 54 is a gear disposed in the middle portion of a complex gear formed integrally in the three stages in the axis direction. Gears are not provided in the gear 54 on the entire circumference, but they are lacked partially.

A gear 55 having a large diameter is formed on the one end portion in the axis direction of the gear 54, and a gear 56 having the same diameter is formed on the other end. The gear 55 is engaged with a gear to be described later for driving the above-mentioned tray 22. The gear 54 can be engaged with the rack 48e of the above-mentioned slide cam 48, and it cannot be engaged with the gear 53 in a state with the chassis 23 at the raised position. A gear 56 is engaged with the gear 53 in a state with the chassis 23 at the lowered position.

Here, as shown in FIG. 10 above, in a state with the optical head 31 transported by the driving motor 24 at a position on the outer circumference side with respect to the innermost circumference of the optical disk, although the gears 52, 53 can be rotated, the gear 54 is not rotated since the gear lacking portion thereof faces the gear 53.

Thereafter, as shown in FIG. 11, in the case the optical head 31 is further rotated by the driving motor 24 in the direction toward the turn table 30 in a state with the optical head 31 reached at the innermost circumference position of the optical disk, the optical head 31 is not moved and only the rack piece 43b is moved, resisting to the pressuring force of the coil spring 43c.

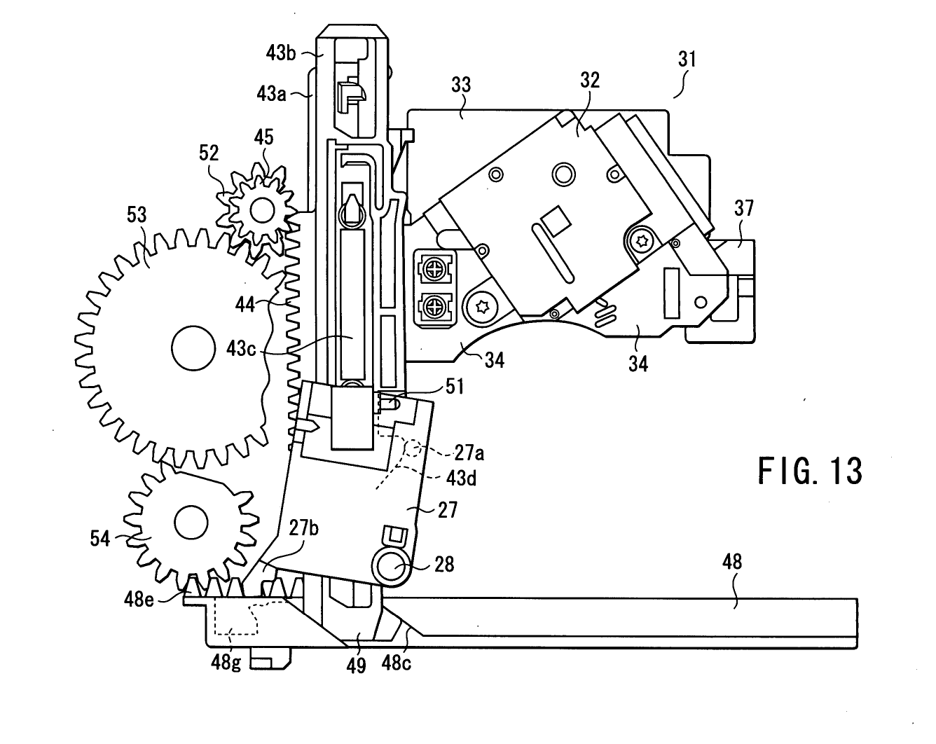

Then, the cam driving section 49 at the top end of the rack piece 43b pressures the cam surface 48b of the slide cam 48 so as to slide the slide cam 48 in the left direction in FIG. 11. At the time, as shown in FIG. 13, the rack 48e of the slide cam 48 rotates the gear 54, and thereby, the gear 54 is engaged with the gear 53.

Therefore, the slide cam 48 is moved further in the left direction in FIG. 13 according to the rotation force of the driving motor 24. In the state of FIG. 13, since the driving member 27 has the pin 27a pressed by the cam portion 43d of the rack piece 43b and it is in a state rotated in the clockwise direction, the detection switch 51 is maintained in the off state.

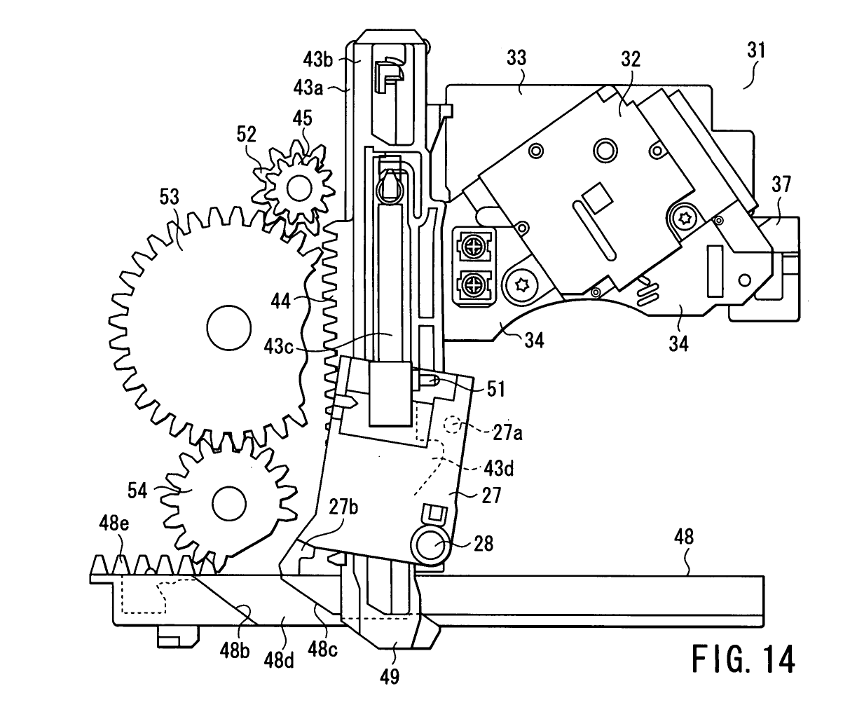

Thereafter, in the case the slide cam 48 is slid continuously in the left direction, as shown in FIG. 14, the cam driving section 49 of the rack piece 43b is driven by the cam surface 48c of the slide cam 48 so that the cam driving section 49 moves across the slide cam 48 in the thickness direction so as to be engaged on the rear surface thereof.

At the time, the rack 44 of the rack piece 43b is detached from the pinion gear 45 so that the rack piece 43b cannot be moved. Moreover, at the time, the chassis 23 has the boss 23b received the force in the lowering direction by the cam hole 48a of the slide cam 48 according to slide of the slide cam 48 so as to be lowered.

Then, according to lowering of the chassis 23, the gear to be engaged with the gear 53 is switched from the gear 54 to the gear 56, however, since the gear 54 and the gear 56 are provided concentrically, the rotation of the gear 54 is continued.

Although the pin 27a of the driving member 27 is detached from the cam portion 43d of the rack piece 43b in the state of FIG. 14, since the driving member 27 has the projection portion 27b engaged with the wall surface of the slide cam 48 so as to be in the state rotated in the clockwise direction, the detection switch 51 is maintained in the off state.

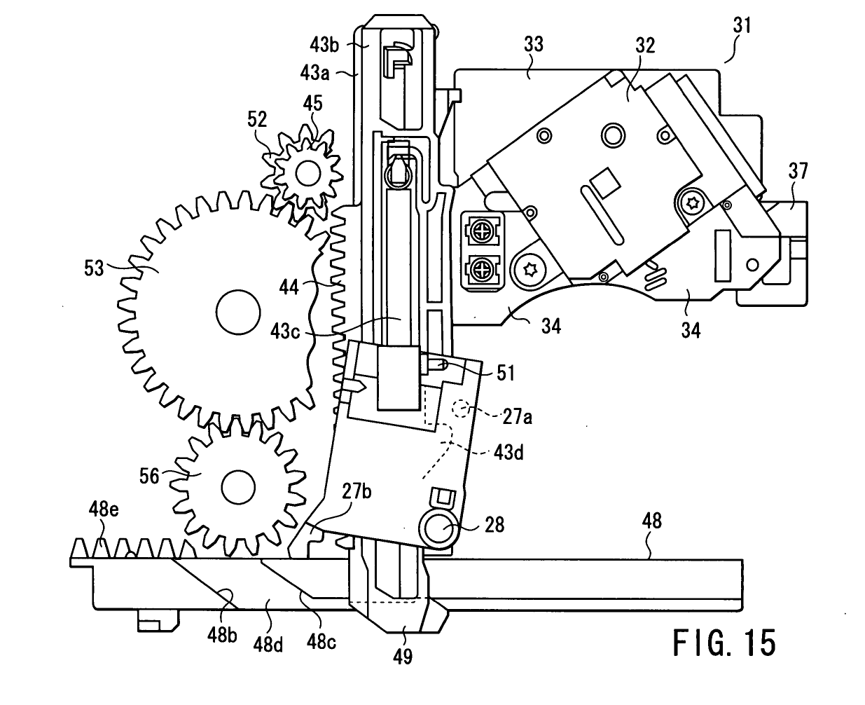

Thereafter, as shown in FIG. 15, in the case the tray 22 starts movement in the pulling out direction according to lowering of the chassis 23, the slide cam 48 is slid in the left direction by the function of the cam projection portion to be described later of the tray 22, and thereby, the rack 48e is completely detached from the gear 56 so as not to be driven by the driving motor 24.

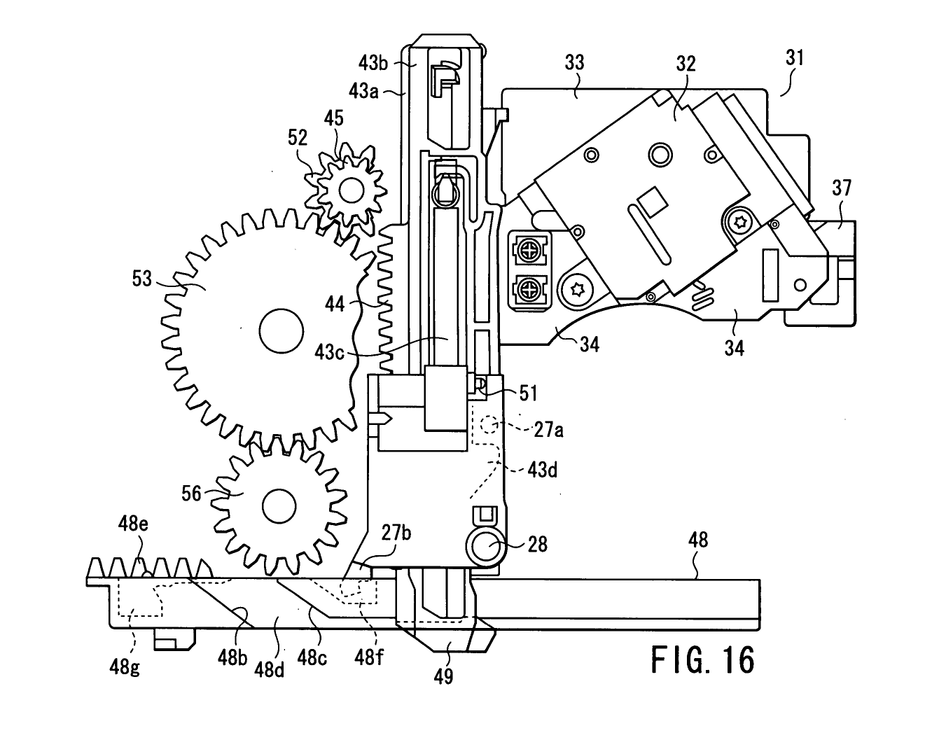

Then, at the time the tray 22 reaches at the position for completing the pulling out operation thereof, the slide cam 48 is moved further in the left direction according to the function of the cam projection portion of the tray 22. At the time, as shown in FIG. 16, the driving member 27 has the projection portion 27b thereof inserted in the groove 48f of the slide cam 48 so as to be rotated in the counterclockwise direction. Thereby, the detection switch 51 is operated in the on state so that the arrival of the tray 22 at the pulling out position can be detected.

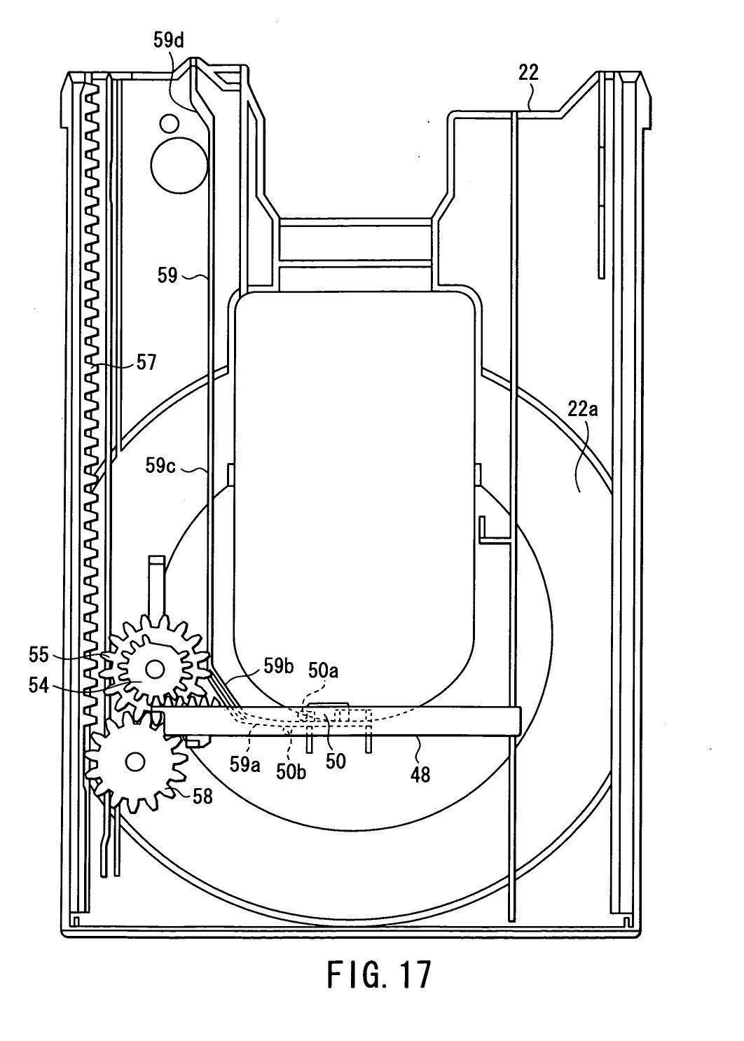

Next, the operation of the tray 22 will be explained. FIG. 17 shows the slide cam 48 and the rack piece 43b in the state of FIG. 11. The rack 57 is formed on one side surface of the tray 22, and the gear 58 engageable with the rack 57 is supported by the base member 18 rotatably. The gear 58 is always engaged with the above-mentioned gear 55. Moreover, since the gear 54 is not engaged with the gear 53 in this state, the gears 55, 58 are not rotated.

Here, a cam projection portion 59 is formed in the tray 22. The cam projection portion 59 includes a portion 59a elongating in the tray 22 width direction, a first cam portion 59b, a portion 59c elongating in the tray 22 sliding direction, and a second cam portion 59d formed continuously. The cam projection portion 59 is provided so as to be interposed between the projection portion 50a of the above-mentioned slide cam 48 and the pin 50b.

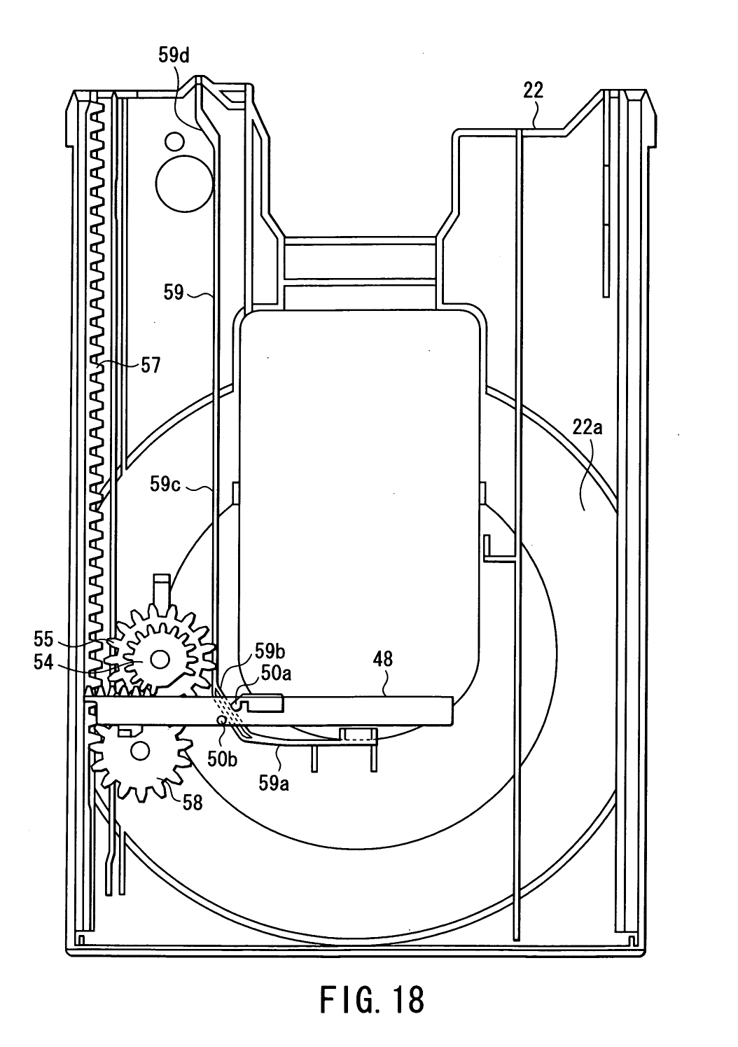

As it is explained with reference to FIG. 11, in the case the sliding operation of the slide cam 48 is started by pressing the cam surface 48b of the slide cam 48 by the cam driving section 49 of the rack piece 43b, as shown in FIG. 18, the projection portion 50a of the slide cam 48 presses the first cam portion 59b so that the tray 22 is slide in the direction to be pulled out from the base member 18.

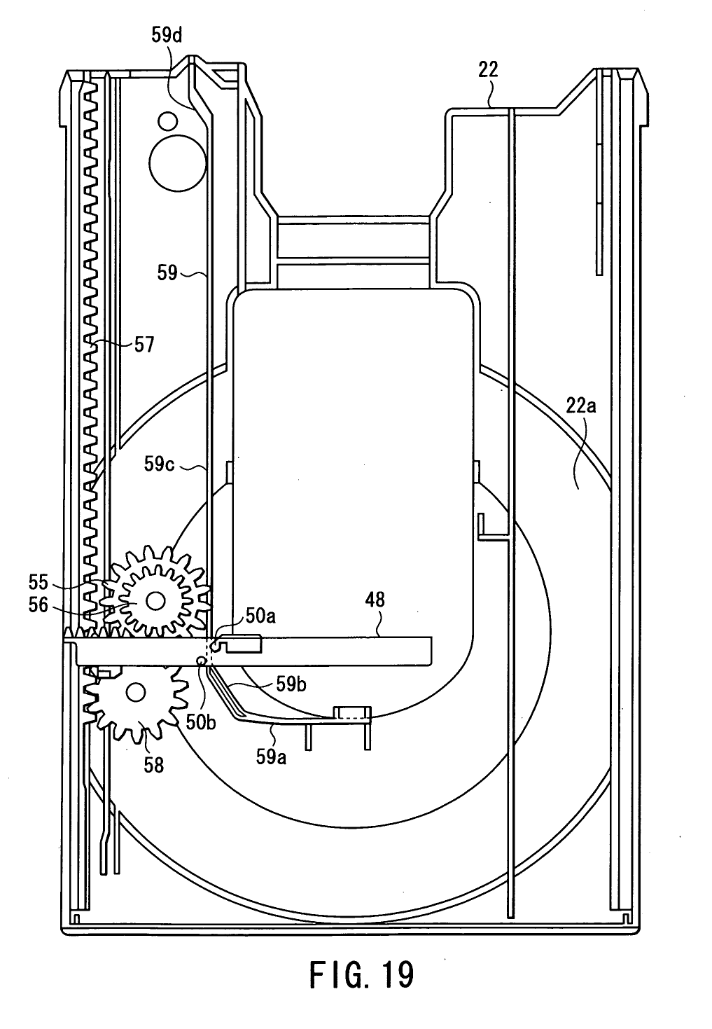

Thereby, the rack 57 of the tray 22 is engaged with the gear 58. At the time, the gear 53 is engaged with the gear 56 so that the tray 22 is pulled out from the base member 18 according to the rotation force of the driving motor 24. In the case the driving motor 24 is further rotated, it is in the state shown in FIG. 19. At the time, the projection portion 50a of the slide cam 48 and the pin 50b are at a position so as to interpose the portion 59c of the cam projection portion 59 therebetween.

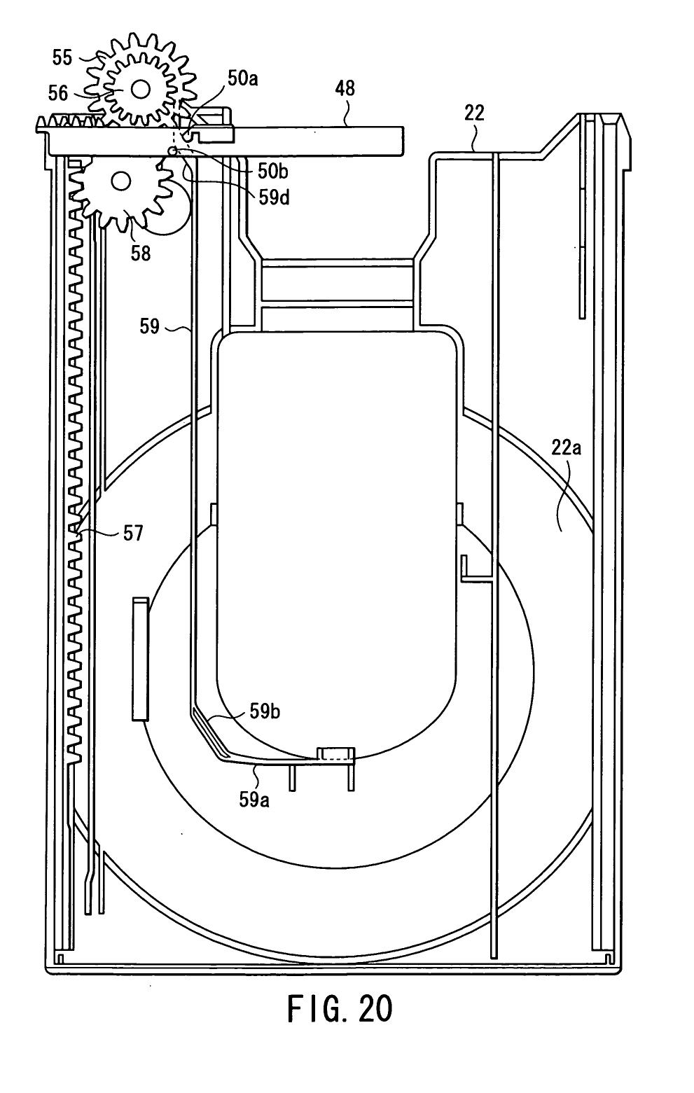

Accordingly, in the case the tray 22 is pulled out from the base member 18 mostly, it is in the state shown in FIG. 20. This state is same as the state shown in FIG. 16. FIG. 20 shows the state with the pin 50b of the slide cam 48 contacted with the second cam portion 59d according to the movement of the tray 22 so that the slide cam 48 is slide further in the left direction.

According to the slide cam 48 sliding operation by the second cam portion 59d, as shown in FIG. 16, the projection portion 27b of the driving member 27 is inserted in the groove 48f of the slide cam 48 so that the detection switch 51 is in the on state for detecting that the tray 22 is completely pulled out from the base member 18.

The drive of the optical head 31, the drive of the chassis 23, and the drive of the tray 22 as described above are executed continuously according to the rotation of the driving motor 24 in one direction. Moreover, by rotating and driving the driving motor 24 in the opposite direction from the state shown in FIGS. 16 and 20, storage of the tray 22 in the base member 18, elevation of the chassis 23, and drive of the optical head 31 in the optical disk diameter direction can be executed.

Moreover, in the case the tray 22 is driven from the pulled out state into the direction to be stored in the base member 18, the projection portion 50a of the slide cam 48 is pressed by the second cam portion 59d so that the slide cam 48 is slid in the right direction in FIG. 20. Therefore, since the projection portion 27b of the driving member 27 is rotated in the clockwise direction so as to be detached from the groove 48f of the slide cam 48 and engaged with the wall surface of the slide cam 48, the detection switch 51 is switched into the off state.

Thereafter, in the case the tray 22 is stored in the base member 18 to the position shown in FIG. 18, since the projection portion 50a of the slide cam 48 is contacted with the first cam portion 59b of the tray 22, the rack 48e of the slide cam 48 and the gear 54 are engaged, interlocked with the tray 22 storing operation to the base member 18 so that the slide cam 48 is slid further in the right direction according to the rotation force of the driving motor 24.

Thereby, since the tray 22 is moved further in the direction to be stored in the base member 18 according to the first cam portion 59b pressing operation by the pin 50b of the slide cam 48, as shown in FIG. 17, the rack 57 of the tray 22 is detached from the gear 58 so that the tray 22 is stopped.

According to the slide cam 48 sliding operation in the right direction in the figure, the chassis 23 is raised so that the gear to be engaged with the gear 53 is switched from the gear 56 to the gear 54. Moreover, although the pinion gear 45 and the rack 44 are not engaged in FIG. 14, according to the slide cam 48 sliding operation in the right direction, as shown in FIG. 13, the cam driving section 49 of the rack piece 43b is pushed by the cam surface 48b of the slide cam 48 so that the rack piece 43b is moved upward in the figure and the rack 44 is engaged with the pinion gear 45.

Furthermore, according to the rotation of the pinion gear 45 by the rotation of the driving motor 24, the slide cam 48 is driven and slid by the cam driving section 49 from the state shown in FIG. 13 to the state shown in FIG. 11, and thereby, the gear 54 is rotated to a position not to be engaged with the gear 53.

The projection portion 27b of the driving member 27 is contacted with the wall surface of the slide cam 48 from the state shown in FIG. 14 to 13, and the pin 27a of the driving member 27 is contacted with the cam portion 43d of the rack piece 43b in the state shown in FIG. 13 so that the detection switch 51 is maintained in the off state.

Moreover, according to the movement from FIG. 13 to FIG. 11, the projection portion 27b of the driving member 27 is at a position corresponding to the groove 48g of the slide cam 48. Since the pin 27a is contacted with the cam portion 43d, the detection switch 51 is maintained in the off state.

Thereafter, according to the movement of the optical head 31 from the position shown in FIG. 11 in the direction shown in FIG. 10, the pin 27a of the driving member 27 is detached from the cam portion 43d of the rack piece 43b, and the projection portion 27b enters into the groove 48g of the slide cam 48 so that the driving member 27 is rotated in the counterclockwise direction for switching the detection switch 51 into the on state.

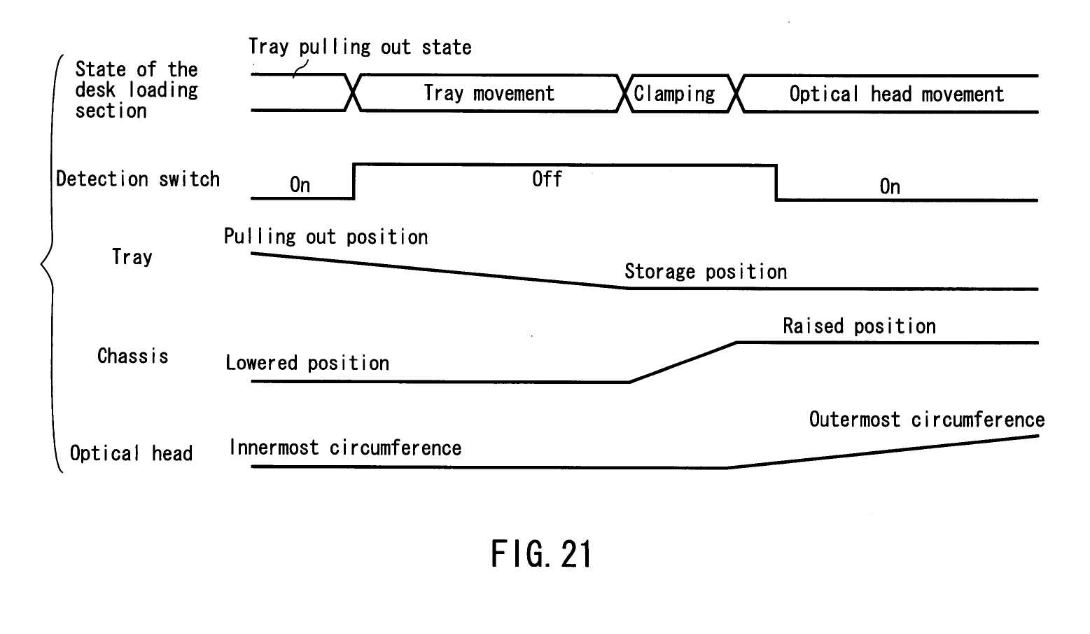

FIG. 21 shows the operation timing of the detection switch 51, the tray 22, the chassis 23 and the optical head 31 as the state transition of the disk loading section 14 in a series of operation of storing the tray 22 in the pulled out state into the base member 18 and moving the optical head.

That is, in the state with the tray 22 pulled out, the detection switch 51 is in the on state, the tray 22 is at the completely pulled out position, the chassis 23 is at the lowered position, and the optical head 31 is controlled to the innermost circumference position.

In the case the driving motor 24 is rotated and driven to the position for storing the tray 22 into the base member 18 in this state, the tray 22 is moved to the storage position into the base member 18. Accompanied thereby, the slide cam 48 is moved from the position shown in FIG. 16 to FIG. 15 so that the detection switch 51 is switched from the on state to the off state.

In the case the tray 22 is stored in the base member 18 accordingly, the chassis 23 is raised for executing disk clamping of clamping the optical disk between the turn table 30 and the clamping member 21.

Then, at the time the disk clamping operation is completed, the optical head 31 is moved from the innermost circumference position to the outer circumference direction of the optical disk. At the time the optical head 31 reaches at a predetermined position, the detection switch 51 is switched from the off state to the on state. The switching operation of the detection switch 51 from the off state to the on state at the time corresponds to the arrival of the optical head 31 to the reference position for recording or reproduction with respect to the optical disk.

Moreover, in the case the driving motor 24 is rotated and driven in the direction for pulling out the tray 22 from the base member 18 in a state with the optical head 31 facing the optical disk, the optical head 31 is moved to the innermost circumference direction of the optical disk. At the time the optical head 31 reaches at a predetermined position, the detection switch 51 is switched from the on state to the off state.

Then, after moving the optical head 31 to the innermost position of the optical disk, the chassis 23 is lowered so that the turn table 30 is moved away from the optical disk, and the optical disk is placed on the disk placing section 22a of the tray 22.

Thereafter, at the time the tray 22 is pulled out from the base member 18 and reaches at a predetermined pulling out position, the detection switch 51 is switched from the off state to the on state. The switching operation of the detection switch 51 from the off state to the on state corresponds to the arrival of the tray 22 to the predetermined pulling out completing position for mounting or taking out the optical disk.

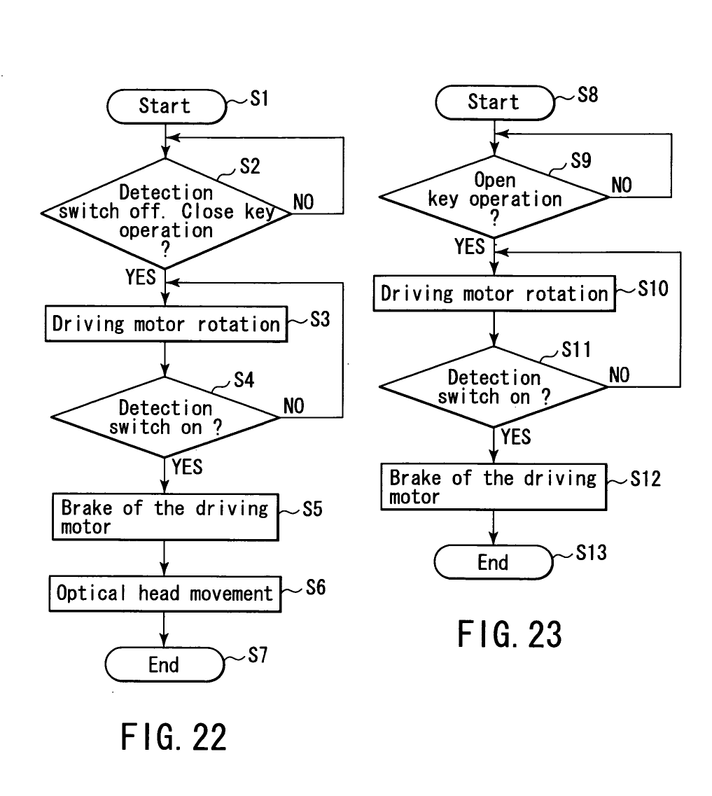

FIG. 22 is a flow chart of a series of the operation of moving the tray 22 from the pulling out position to the storage position. First, this operation is started in a state with the tray 22 pulled out (step S1).

Then, in the case the detection switch 51 is switched from the on state to the off state, or a close key (not shown) is operated in step S2, the driving motor 24 is rotated and driven in the direction for storing the tray 22 into the base member 18 in step S3.

Thereafter, in the case the detection switch 51 is switched from the off state to the on state in step S4, the driving motor 24 is braked in step S5, and the optical head 31 is moved in step S6 so as to finish the operation (step S7).

FIG. 23 is a flow chart of a series of the operation of moving the tray 22 from the storage position to the pulling out position. First, this operation is started in a state with the tray 22 stored in the base member 18 (step S8).

Then, in the case an open key (not shown) is operated in step S9, the driving motor 24 is rotated and driven in the direction for pulling out the tray 22 from the base member 18 in step S10.

Thereafter, in the case the detection switch 51 is switched from the off state to the on state in step S11, the driving motor 24 is braked in step S12 so as to finish the operation (step S13).

According to the above-mentioned embodiment, since the arrival of the tray 22 to the predetermined pulling out completing position for mounting or taking out the optical disk, and the arrival of the optical head 31 to the reference position for recording or reproduction with respect to the optical disk can be detected by one detection switch 51 without the need of a special specification, a small size and a thin shape can be promoted in a simple configuration, and furthermore, it can be provided sufficiently for the practical use.

The present invention is not limited to the above-mentioned embodiment, and it can be embodied with various modification of the constituent elements within a range of the gist thereof in the practical stage. Moreover, various inventions can be formed by optionally combining a plurality of the constituent elements disclosed in the above-mentioned embodiment. For example, several constituent elements may be omitted form the entire constituent components shown in the embodiment. Furthermore, the constituent components in the different embodiments can be used optionally in a combination.

What is claimed is:

1. A disk loading device comprising:
a tray driving mechanism configured to move a tray capable of placing a disk thereon between a position taken out from a cabinet and a position stored in the cabinet according to the driving force applied from the outside;
a disk driving section driving mechanism configured to move a disk driving section to mount, rotate and drive the disk placed on the tray stored in the cabinet between a position for mounting the disk and a position for detaching the disk according to the driving force applied from the outside;
a head driving mechanism which is moved together with the disk driving section by the disk driving section driving mechanism, and configured to move a head in the diameter direction of the disk mounted in the disk driving section according to the driving force applied from the outside;
a controlling mechanism which is engaged selectively with the tray driving mechanism, the disk driving section driving mechanism, and the head driving mechanism, and configured to successively move the tray, the disk driving section and the head in this order or in the opposite order by selectively applying the driving force from the same driving source to each driving mechanism; and
a switch driving mechanism configured to control the switch in either of the on and off states in a state with the tray reach at the pulling out reference position from the cabinet according to the contact or detachment of the member interlocked with the operation of the controlling mechanism, and to control the same in the other of the on and off states with the head reach at the reference position for recording or reproduction with respect to the disk.

2. A disk loading device according to claim 1, wherein the controlling mechanism controls such that it provides the driving force from the same driving source to the tray driving mechanism for moving the tray in the direction to be stored in the cabinet, it provides the driving force from the same driving source to the disk driving section driving mechanism in a state with the tray stored in the cabinet, and it provides the driving force from the same driving source to the head driving mechanism in a state with the disk mounted in the disk driving section for moving the head in the disk diameter direction in the case the tray pulled out from the cabinet is to be stored in the cabinet.

3. A disk loading device according to claim 2, wherein the switching driving mechanism controls the switch in either of the on and off states at the time the tray reaches at the pulling out reference position from the cabinet in a state with the driving force from the same driving source applied to the tray driving mechanism so that the tray is moved in the direction to be stored in the cabinet.

4. A disk loading device according to claim 1, wherein the controlling mechanism controls such that it provides the driving force from the same driving source to the head driving mechanism for moving the head to the reference position of the disk, it provides the driving force from the same driving source to the disk driving section driving mechanism for moving the disk driving section in the direction moving away from the disk after arrival of the head to the reference position of the disk, and it provides the driving force from the same driving source to the tray driving mechanism for moving the tray in the direction to be pulled out from the cabinet in a state with the disk detached from the disk driving section in the case the tray stored in the cabinet is to be pulled out from the cabinet.

5. A disk loading device according to claim 4, wherein the switch driving mechanism controls the switch in the other state of the on and off states in a state with the head moved to the reference position of the disk by providing the driving force from the same driving source to the head driving mechanism.

6. A disk loading device according to claim 1, 2, 3, 4 or 5, wherein the controlling mechanism comprises a slide cam to be engaged with the tray driving mechanism, the disk driving section driving mechanism and the head driving mechanism, respectively so that the driving timing of the tray driving mechanism, the disk driving section driving mechanism and the head driving mechanism is controlled by the slide cam.

7. A disk loading method comprising:
selectively providing the driving force from the same driving source to a tray driving mechanism, a disk driving section driving mechanism and a head driving mechanism for moving a tray, a disk driving section and a head successively in this order or in the opposite order; and
selectively controlling the same switch in the on and off states between a state with the tray reach at the pulling out reference position from a cabinet and a state with the head reach at the reference position for recording or reproduction with respect to a disk in a disk loading device comprising the tray driving mechanism configured to move the tray capable of placing the disk thereon between a position taken out from the cabinet and a position stored in the cabinet according to the driving force applied from the outside;
the disk driving section driving mechanism configured to move the disk driving section to mount, rotate and drive the disk placed on the tray stored in the cabinet between a position for mounting the disk and a position for detaching the disk according to the driving force applied from the outside; and
the head driving mechanism which is to be moved together with the disk driving section by the disk driving section driving mechanism, and configured to move the head in the diameter direction of the disk mounted in the disk driving section according to the driving force applied from the outside.

8. A disk loading method according to claim 7, wherein:
the selectively providing the driving force from the same driving source to the tray driving mechanism, the disk driving section driving mechanism and the head driving mechanism is executed by providing the driving force from the same driving source to the tray driving mechanism for moving the tray in the direction to be stored in the cabinet;
providing the driving force from the same driving source to the disk driving section driving mechanism in a state with the tray stored in the cabinet; and
providing the driving force from the same driving source to the head driving mechanism in a state with the disk mounted in the disk driving section for moving the head in the disk diameter direction in the case the tray pulled out from the cabinet is to be stored in the cabinet.

9. A disk loading method according to claim 8, wherein the selectively controlling the switch in the on and off states is executed by controlling the switch in either of the on and off states at the time the tray reaches at the pulling out reference position from the cabinet in a state with the driving force from the same driving source applied to the tray driving mechanism so that the tray is moved in the direction to be stored in the cabinet.

10. A disk loading method according to claim 7, wherein the selectively providing the driving force from the same driving source to the tray driving mechanism, the disk driving section driving mechanism and the head driving mechanism is executed by providing the driving force from the same driving source to the head driving mechanism for moving the head to the reference position of the disk;
providing the driving force from the same driving source to the disk driving section driving mechanism for moving the disk driving section in the direction moving away from the disk after arrival of the head to the reference position of the disk; and
providing the driving force from the same driving source to the tray driving mechanism for moving the tray in the direction to be pulled out from the cabinet in a state with the disk detached from the disk driving section in the case the tray stored in the cabinet is to be pulled out from the cabinet.

11. A disk loading method according to claim 10, wherein the selectively controlling the switch in the on and off states is executed by controlling the switch in the other state of the on and off states in a state with the head moved to the reference position of the disk by providing the driving force from the same driving source to the head driving mechanism.

12. A disk loading method according to claim 7, 8, 9, 10 or 11, wherein the selectively providing the driving force from the same driving source to the tray driving mechanism, the disk driving section driving mechanism and the head driving mechanism is executed by providing a slide cam to be engaged with the tray driving mechanism, the disk driving section driving mechanism and the head driving mechanism, respectively so that the driving timing of the tray driving mechanism, the disk driving section driving mechanism and the head driving mechanism is controlled by the slide cam.

13. An optical disk apparatus comprising:
a tray driving mechanism configured to move a tray capable of placing a disk thereon between a position taken out from a cabinet and a position stored in the cabinet according to the driving force applied from the outside;
a disk driving section driving mechanism configured to move a disk driving section to mount, rotate and drive the disk placed on the tray stored in the cabinet between a position for mounting the disk and a position for detaching the disk according to the driving force applied from the outside;
a head driving mechanism which is to be moved together with the disk driving section by the disk driving section driving mechanism, and configured to move a head in the diameter direction of the disk mounted in the disk driving section according to the driving force applied from the outside;
a controlling mechanism which is to be engaged selectively with the tray driving mechanism, the disk driving section driving mechanism, and the head driving mechanism, and configured to successively move the tray, the disk driving section and the head in this order or in the opposite order by selectively applying the driving force from the same driving source to each driving mechanism; and
a switch driving mechanism configured to control the switch in either of the on and off states in a state with the tray reach at the pulling out reference position from the cabinet according to the contact or detachment of the member interlocked with the operation of the controlling mechanism, and to control the same in the other of the on and off states with the head reach at the reference position for recording or reproduction with respect to the disk;
wherein a recording or reproducing operation is executed with respect to the disk in a state with the switch controlled in the other state of the on and off states by the arrival of the head to the reference position for executing the recording or reproducing operation with respect to the disk by the switch driving mechanism.

14. An optical disk apparatus according to claim 13, wherein the controlling mechanism controls such that it provides the driving force from the same driving source to the tray driving mechanism for moving the tray in the direction to be stored in the cabinet, it provides the driving force from the same driving source to the disk driving section driving mechanism in a state with the tray stored in the cabinet, and it provides the driving force from the same driving source to the head driving mechanism in a state with the disk mounted in the disk driving section for moving the head in the disk diameter direction in the case the tray pulled out from the cabinet is to be stored in the cabinet.

15. An optical disk apparatus according to claim 14, wherein the switching driving mechanism controls the switch in either of the on and off states at the time the tray reaches at the pulling out reference position from the cabinet in a state with the driving force from the same driving source applied to the tray driving mechanism so that the tray is moved in the direction to be stored in the cabinet.

16. An optical disk apparatus according to claim 13, wherein the controlling mechanism controls such that it provides the driving force from the same driving source to the head driving mechanism for moving the head to the reference position of the disk, it provides the driving force from the same driving source to the disk driving section driving mechanism for moving the disk driving section in the direction moving away from the disk after arrival of the head to the reference position of the disk, and it provides the driving force from the same driving source to the tray driving mechanism for moving the tray in the direction to be pulled out from the cabinet in a state with the disk detached from the disk driving section in the case the tray stored in the cabinet is to be pulled out from the cabinet.

17. An optical disk apparatus according to claim 16, wherein the switch driving mechanism controls the switch in the other state of the on and off states in a state with the head moved to the reference position of the disk by providing the driving force from the same driving source to the head driving mechanism.

18. An optical disk apparatus according to claim 13, 14, 15, 16, or 17, wherein the controlling mechanism comprises a slide cam to be engaged with the tray driving mechanism, the disk driving section driving mechanism and the head driving mechanism, respectively so that the driving timing of the tray driving mechanism, the disk driving section driving mechanism and the head driving mechanism is controlled by the slide cam.
